(19) United States
(12) Patent Application Publication
(10) Pub. No.: US 2009/0232472 A1
(43) Pub. Date: Sep. 17, 2009

(54) METHODS AND APPARATUS FOR PROVIDING USAGE TIMERS FOR A PRESENTATION DEVICE

(75) Inventor: Eric Christopher Pleiman, Englewood, CO (US)

Correspondence Address: EchoStar Technologies, L.L.C.;Legal Department, 9601 SOUTH MERIDIAN BOULEVARD, ENGLEWOOD, CO, 80112, US

(73) Assignee: EchoStar Technologies L.L.C., Englewood, CO (US)

(21) Appl. No.: 12/046,079

(22) Filed: Mar. 11, 2008

(51) Int. Cl. G09G 3/32

(52) U.S. Cl. 386/83

(57) ABSTRACT

Apparatus, systems and methods are provided for implementing usage timers on an electronic device. A usage timer provides a time budget for a user's access to the electronic device and more specifically limits the user's access to of content provided by the electronic device. As the user utilizes the electronic device to experience content, their associated time budget for the electronic device is debited accordingly. Once the user's time budget for using the electronic device is exceeded, their access to the electronic device is restricted. However, when the user is utilizing certain functions on the electronic device (e.g., trick play mode functions, viewing a content selection menu or loading content), their time budget is not debited for the time spent utilizing these functions of the electronic device.

### BACKGROUND

Many parents feel that children spend too much time watching television and using other electronic devices. Usage timers have been developed that allow a parent to restrict the amount of time that a child is allowed to spend utilizing an electronic device. For example, a usage timer may restrict a child to watching television for one hour per day. After the child has watched television for one hour that day, the usage timer suspends the child's access to the television for the rest of the day. While these usage timers are effective for limiting a child's access to an electronic device, they are often un-flexible, and operate to decrement time from the child's account during the entire time that the electronic device is powered on. Thus, present usage timers for electronic devices do not take into account how the child is presently using the electronic device when decrementing time from the child's time budget.

### BRIEF DESCRIPTION OF THE DRAWINGS

The same number represents the same element or same type of element in all drawings.

FIG. 1 illustrates an embodiment of an entertainment system.

FIG. 2 illustrates an embodiment of functional components of the content source of FIG. 1

FIG. 3 illustrates a screenshot of an embodiment of an electronic programming guide.

FIG. 4 illustrates a screenshot of another embodiment of an electronic programming guide.

FIG. 5 illustrates a screenshot of an embodiment of content outputted for presentation by the content source of FIG. 1.

FIG. 6 illustrates an embodiment of a process for controlling usage timers for a presentation device.

### DETAILED DESCRIPTION

The various embodiments described herein generally provide apparatus, systems and methods for implementing usage timers on an electronic device. A usage timer provides a time budget for a user's access to the electronic device and more specifically limits the user's experience of content provided by the electronic device. As the user utilizes the electronic device to experience content, their associated time budget for the electronic device is debited accordingly. Once the user's time budget for using the electronic device is exceeded, their access to the electronic device is restricted. In short, various embodiments described herein provide apparatus, systems and/or methods for controlling usage timers for a presentation device.

The presentation device may comprise any device capable of presenting audio content, video content, audio/video (A/V) content, image content or any other type of content. In at least one embodiment, the electronic device is a video playback device, such as a digital video recorder (DVR) capable of outputting recorded video content for display on an associated display device (e.g., a television). Thus, the usage timer for the DVR controls the amount of time that the user may view content on the DVR. However, when the user is utilizing certain functions on the electronic device, their time budget is not debited for the time spent utilizing these functions of the electronic device. In at least one embodiment, the usage timer does not debit the user for time spent performing trick play mode functions (e.g., fast forwarding, reversing or moving backwards, pausing the content or otherwise skipping through the content at a rate different than the real-time presentation rate of the content). In at least one embodiment, the usage timer does not debit the user for time spent viewing a content selection menu (e.g., an electronic programming guide) or for time spent by the electronic device buffering, retrieving and/or loading presentation content. Therefore, the techniques described herein provide greater flexibility for limiting a user's access to presentation content by dynamically adjusting the usage timer to account for time that is not actually utilized by the user experiencing content presented by the presentation device.

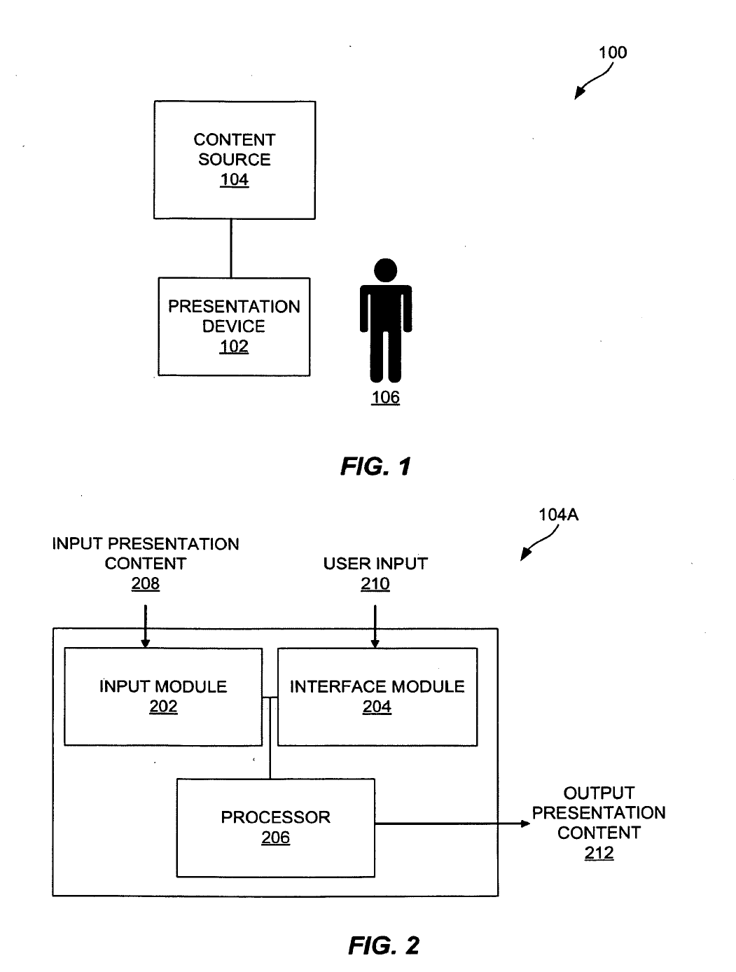

FIG. 1 illustrates an embodiment of an entertainment system 100. The entertainment system 100 presents content to a user 106. In at least one embodiment, the content presented to the user 106 includes a video stream, such as a television program, movie or other recorded content and the like. The entertainment system 100 includes a presentation device 102 and a content source 104. Each of these components is discussed in greater detail below.

The presentation device 102 is configured to receive content from one or more content source(s) 104, and to present the received content to the user 106. In at least one embodiment, the presentation device 102 is a display device configured to display content to the user 106. The presentation device 102 may receive a video stream in any format (e.g., analog or digital format), and present the video stream to the user 106. In other embodiments, the presentation device 102 comprises an audio playback system (e.g., a stereo or MP3 player) configured to playback live or recorded audio content to a user. Likewise, the presentation device 102 may receive the audio content in any format (e.g., analog or digital format) and reproduce the received audio content for the user 106.

The content source 104 may comprise any system or apparatus configured to output presentation data, such as a video stream, to the presentation device 102 for presentation. The content source 104 may be external or internal to the presentation device 102. The presentation device 102 and the content source 104 may be communicatively coupled through any type of wired or wireless connection, communication network and the like. Exemplary content sources include television distribution systems (e.g., over the air distribution systems, cable television distribution systems, satellite television distribution systems and broadband distribution systems), set-top boxes, DVD players and other optical disk players, digital storage mediums (e.g., DVRs) and the internet. It is to be appreciated that the presentation device 102 may also be embodied as an apparatus combining the functionality of a display device and a set-top box, DVR or the like or combining the functionality of a music player (e.g., MP3 player) and speakers.

In at least one embodiment, the content source 104 may provide other types of data and/or content to the presentation device 102. For example, the content source 104 may comprise a video game system that outputs a signal to the presentation device 102 for display to the user 106. The content source 104 may also comprise a computer that outputs visual representations of documents, web pages, images, application interfaces and the like for presentation by the presentation device 102. For example, the content source 104 may allow a user to browse the internet, with web pages displayed by the presentation device 102.

The presentation device 102 and/or the content source 104 may include one or more user input devices for controlling the output of content on the presentation device 102. In at least one embodiment, the input device is a hand-held remote control configured to wirelessly control the presentation device 102 and/or content source 104. For example, the remote control may communicate with the presentation device 102 and/or the content source 104 using an infrared (IR) or radio frequency (RF) communication link. In other embodiments, the input device may comprise a keyboard or other input device communicatively coupled to the presentation device 102 and/or the content source 104 using a wired or wireless communication link. In at least one embodiment, the content source 104 is configured to wirelessly communicate with an input device operated by the user 106, and responsive to input from the user 106, transmits one or more commands to the presentation device 102 that control the presentation of content by the presentation device 102. For example, the content source 104 may include an IR blaster adapted to transmit IR codes to the presentation device 102 that control various functions of the presentation device 102 (e.g., channel changes, volume changes, picture-in-picture (PIP) and the like).

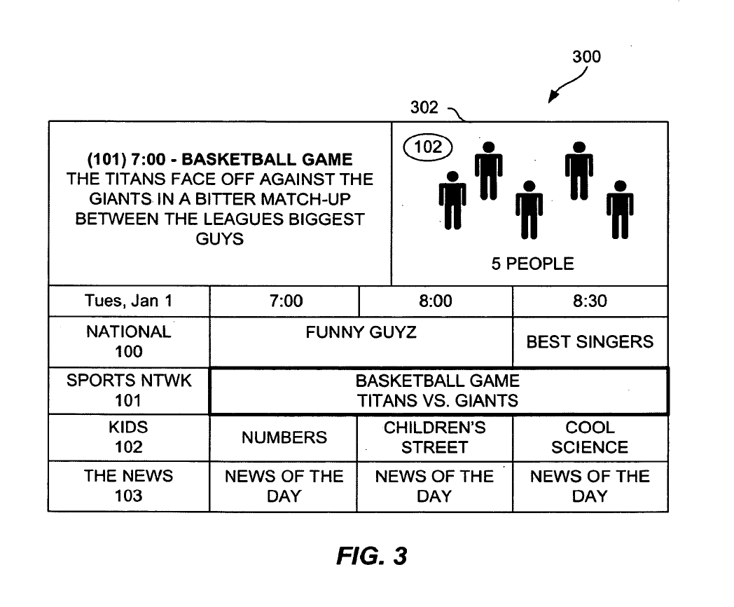

FIG. 2 illustrates an embodiment of functional components of the content source 104A of FIG. 1. FIG. 2 will be discussed in reference to the entertainment system 100 illustrated in FIG. 1. The content source 104A comprises an input module 202, an interface module 204 and a processor 206. Each of these components is discussed in greater detail below.

The input module 202 receives input presentation content 208 from one or more input sources (not shown in FIG. 2). The input sources may include any source of content, such as external broadcast networks, external data networks, external or internal storage mediums, internally loaded optical disks and the like. In at least one embodiment, the input module 202 comprises a wired or wireless television broadcast receiver/tuner. For example, the input module 202 may receive cable television signals, satellite television signals or over-the-air broadcast signals from a television distribution network. In at least one embodiment, the input module 202 is communicatively coupled to the internet or other type of data network, and may receive audio content, video content and/or other data content (e.g., images, web pages and the like) from an external server of the data network.

The input module 202 may also receive the input presentation content 208 from local storage mediums communicatively coupled to the content source 104A. The local storage mediums may be internal or external to the content source 104A. For example, if the content source 104A is a DVR, then the content source may include an internal hard drive or other storage medium. The content source 104A may also include input ports for receiving content from external storage mediums, such as external hard drives, portable storage devices (e.g., USB flash drives), networked storage drives and the like. In at least one embodiment, the content source 104A receives the input presentation content 208 from optical disks (e.g., digital-video-disks (DVDs), compact-disks (CD) and the like). For example, the input module 202 may include circuitry for reading data (e.g., video data) from the optical disks for output by the content source 104A.

The interface module 204 is configured to receive user input 210 from the user 106. The user input 210 manipulates playback of the input presentation content 208 by the content source 104A. For example, the user input 210 may request presentation of the input presentation content 208 on the presentation device 102. The user 106 may input the request to initiate playback of the content using a remote control or other input device (not shown in FIG. 2). Responsive to the request, the content source 104A outputs the output presentation content 212 for presentation by the presentation device 102. The user input 210 may also request trick play mode presentation functions (e.g., fast forwarding, reversing, pausing, chapter skipping and the like) to be performed on the output presentation content 212. In other words, the user input 210 may request temporal movement through the output presentation content 212 at rates that are different than the real-time presentation rate of the output presentation content 212.

As used herein, the real-time presentation rate of content refers to a presentation rate at which the content is intended for presentation. The real-time presentation rate of both audio and video content is typically 1× speed. A trick play mode presentation rate (e.g., fast-forwarding, reversing, pausing, skipping ahead or behind) is thus different than the real-time presentation rate of the output presentation content 212. Thus, a fast forwarding presentation rate is greater than 1× speed (e.g., 4× or 15×) in the forward direction of playback. Similarly, the user 106 may request playback of the output presentation content 212 at a speed of less than 1× (e.g., ¼ speed). A user may also pause playback of the output presentation content 212. During pause mode, the presentation rate is zero, as there is no temporal movement through the content when the pause mode of the content source 104A is activated. Temporal movement through content may also include skipping ahead or behind through chapters or indexed portions of the output presentation content 212.

The processor 206 is configured to output the output presentation content 212 to the presentation device 102. The processor 206 may pass through the input presentation content 208 or may perform various processing techniques to modify and/or reformat the input presentation content 208, such as changing the rate of playback of the input presentation content 208, adding other data (e.g., overlaying icons, menus and the like) to the input presentation content 208 or transcoding the input presentation content 208. The processor 206 may also generate menus allowing the user 106 to manipulate presentation of the output presentation content 212 or to select content for playback from various input sources or files of presentation content. For example, the processor 206 may generate a menu of available presentation content stored on a local storage drive and the user input 210 may select one or more files of content for playback.

In at least one embodiment, the processor 206 includes an audio/video (A/V) encoder and/or decoder for translating the input presentation content 208 from an input format into a format compatible with the presentation device 102. For example, the processor 206 may translate an MP3 audio file into analog audio data for playback on an analog stereo. In at least one embodiment, the processor 206 may translate an analog video input signal into a digital video output signal (e.g., digitizing and compressing an analog video signal) or translate a digital video input signal into an analog video output signal.

The processor 206 is further operable to activate a usage timer for the presentation device 102. The usage timer provides a time budget for the user's 106 access to the content outputted by the content source 104A. For example, a parent may limit the time that a child watches television, listens to music or plays video games. As the user 106 utilizes the content source 104A and the presentation device 102 to experience content, their time budget on the content source 104A and/or the presentation device 102 is debited accordingly. When the user's 106 time budget for using the content source 104A is exceeded, their access to the content source 104A is restricted. Thus, when the time budget is exceeded, the content source 104A ceases the output of the output presentation content 212 to the presentation device 102.

In at least one embodiment, a child (e.g., the user 106) is provided with an account on the content source 104A. There may be multiple accounts for different users of the content source 104A. For example, each child in a family may be provided with their own account for the content source 104A. In at least one embodiment, the user 106 accesses their account using an access code. In other embodiments, the user 106 may access the account using biometric information and the like.

The account may restrict the types of content that the user 106 is entitled to experience. For example, if the content source 104A comprises a DVR or set-top box, then an administrator (e.g., a parent) may select a favorites list of approved channels and recorded content that the user 106 is entitled to access. In at least one embodiment, the “favorite” channels may be filtered based upon specific channels selected by the administrator. For example, when the user 106 enters their access code, the content source 104A may provide a filtered content selection menu (e.g., an electronic programming guide) showing only channels that the user 106 is entitled to view. In other embodiments, the content that the user 106 is entitled to access may be filtered based upon ratings of the content. For example, the user 106 may be restricted from accessing “R” rated content. In at least one embodiment, the administrator is allowed to override the access restrictions. For example, the administrator may have a separate access code to unlock all of the channels or content provided by the content source 104A.

It is to be appreciated that when the content source 104A leaves standby mode or powers up, the content source may be set to display content that is not approved for presentation to the user 106. In other words, the content source 104A may be set to a channel that is not appropriate for viewing by the user 106. Thus, the content source 104A may be configured to jump to the closest channel in value to the previously viewed channel that is on an approved list of viewable content for the user 106. For example, the previous channel prior to powering up may be 202 which the user 106 is not entitled to access. The two closest channels on the user's 106 favorite list above and below channel 202 may be 140 and 220. Thus, the content source 104A jumps to channel 220 after the user 106 logs into their account.

The account may further restrict the time that the user 106 may experience content on the presentation device 102 during a given period of time. For example, the user 106 may be restricted to experiencing 1 hour of content per day, 12 hours per week or 60 hours per month. Thus, as the user 106 experiences content, their associated time budget is decremented based on the time spent experiencing the content. In some embodiments, different time budgets may be provided to the user 106 based on the day of the week. For example, the user 106 may be provided with a time budget of 1 hour per day for experiencing content on school days and may be provided with a time budget 3 hours per day on weekends and/or holidays.

In at least one embodiment, as allocated time from the time budget is utilized by the user 106, the content source 104A may provide an indicator to the user 106 regarding the time remaining for the time budget during the allocated period of time. For example, if the presentation device 102 comprises a television or display device, then the content source 104A may provide an indicator in one of the corners of the output presentation content 212 when 15 minutes, 10 minutes, 5 minutes and/or 2 minutes remain on the time budget. Alternatively, the content source 104A may output other indicators, such as audible indicators, which are presented by the presentation device 102. For example, if the presentation device 102 is an audio playback device presenting an MP3 file to the user 106, then an audible warning may sound during playback of the MP3 file when 2 minutes remain on the time budget of the user 106.

In at least one embodiment, the debiting from the time budget is suspended when the content source 104A and/or presentation device 102 is placed in standby mode or powered down. The debiting of the time budget may also be suspended if another access code is provided to the content source 104A. For example, a parent may log into the content source 104A, suspending debiting from the child's time budget. In at least one embodiment, the debiting of the time budget is suspended when temporally moving through content. Thus, if the user 106 is utilizing a DVR function of the content source 104A or playing back other recorded content (e.g., DVDs), then their time budget is only debited for playback of the content when not pausing, fast-forwarding, reversing, skipping forward or skipping backward in the content.

For example, the user 106 may be allocated with a time budget of 1 hour per day for watching live or recorded content on a television. The user 106 may further desire to watch a recorded movie stored on the content source 104A that is 1 hour and 20 minutes in length. If the user 106 watches 55 minutes of the recorded content, then they will have 5 minutes remaining on their time budget. The user 106 may then spend 2 minutes fast-forwarding through the next 20 minutes of the movie in order to reach the final 5 minutes of the movie. At this time, the user 106 has been logged into the content source 104A for 57 minutes, but because the time spent fast-forwarding was not debited from their time budget, the user 106 will still have 5 minutes left on their time budget to utilize watching the final 5 minutes of the movie.

In at least one embodiment, the time budget of the user 106 is not debited when accessing a content selection menu. A content selection menu allows the user 106 to select content for presentation by the presentation device 102. For example, the content source 104A may be a satellite television set-top box, and the content selection menu may include an electronic programming guide that displays a list of channels that the user 106 is entitled to view. When the user 106 enters the electronic programming guide, the debiting of the time budget of the user 106 may be suspended until the user 106 makes a programming selection and exits the electronic programming guide. The content selection menu may allow the user to select from a list of any type of content that may he presented by the presentation device 102. For example, the content selection menu may allow the user 106 to select a recorded video from a DVR, a stored music file (e.g., an MP3 file) on an MP3 player, a video chapter within a DVD movie or a level of a video game.

Typically, when accessing an electronic programming guide, a user is provided with a “preview” window that occupies about ¼ of the screen of a television. The “preview” window may display video from any selected channel of the television distribution system. For example, the preview window may display video content from the last channel viewed by the user 106 prior to entering the electronic programming guide. In at least one embodiment, the content source 104A may be configured to output the electronic programming guide without the “preview” window when debiting of the time budget of the user 106 is suspended. Thus, a user 106 cannot enter the electronic programming guide to watch a television program with the usage timer suspended, effectively defeating the usage timer. However, the user 106 may be given the option to enable the “preview” window within the electronic programming guide, such as by using a button on a remote control associated with the content source 104A. When the user 106 enables the “preview” window, the usage timer is re-activated, and the subsequent time spent in the electronic programming guide is debited from the time budget of the user 106.

There are other events occurring within a content source 104A upon which the time budget of the user 106 may also not be debited. For example, the time budget of the user 106 may not be debited for buffering video on demand (VOD) movies or for buffering, retrieval and/or loading of any type of content. Thus, the time budget of the user 106 is not debited for time expended by the content source 104A during which the user 106 is not actively experiencing content.

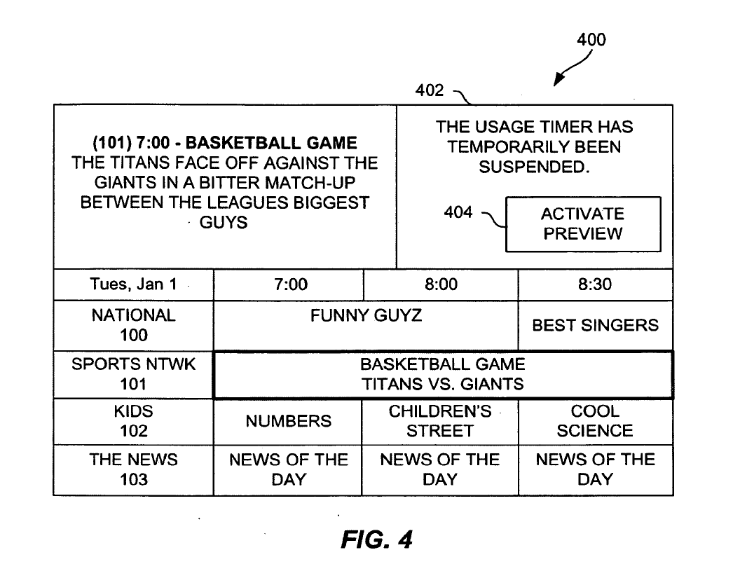

FIG. 3 illustrates a screenshot of an embodiment of an electronic programming guide 300. In at least one embodiment, the electronic programming guide 300 is generated by the content source 104 (see FIG. 1) based on information received from an external source. For example, the content source 104 may receive programming guide data from a satellite television provider through a satellite communication link.

The electronic programming guide illustrates various programs available for viewing by the user 106 (see FIG. 1). The user 106 can highlight a particular program in the electronic programming guide 300 to view a written description of the program. In the upper right-hand corner of the electronic programming guide 300 is a preview 302 of the current program selected for viewing by the user. 102. In the embodiment of FIG. 3, the preview 302 displays the video program “Numbers” shown on channel 102. As described above, in at least one embodiment, the preview 302 is omitted from the electronic programming guide 300 when the usage timer is suspended as the user 106 (see FIG. 1) browses the electronic programming guide.

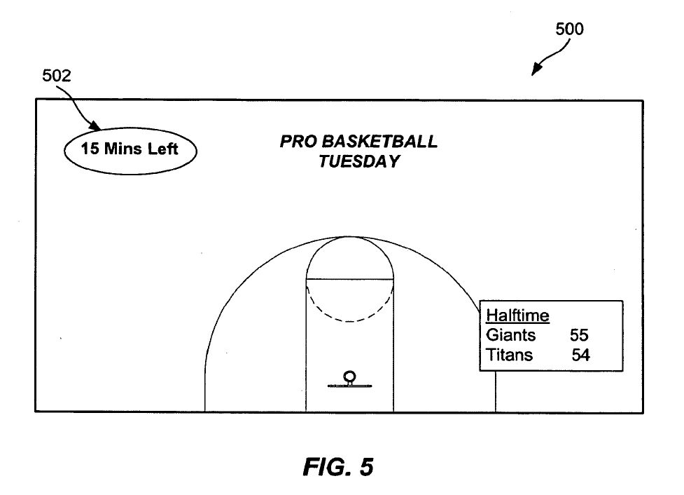

FIG. 4 illustrates a screenshot of another embodiment of an electronic programming guide 400. More particularly, the preview 302 (see FIG. 3) in the electronic programming guide has been replaced with a message 402 informing the user 106 (see FIG. 1) that the usage timer has been temporarily suspended. The user 106 (see FIG. 1) is further given an option to activate the preview function using the button 404 provided in the electronic programming guide 400. However, in the illustrated embodiment, if the user 106 (see FIG. 1) activates the preview function of the electronic programming guide 400, then the usage timer will be re-activated. Thus, the time budget of the user 106 (see FIG. 1) is debited for the remaining time spent in the electronic programming guide 400.

After the time budget of the user 106 (see FIG. 1) expires, the content source 104 and/or the presentation device 102 may be placed in standby mode and/or powered off. The content source 104 may also be configured to output a screen allowing a user to enter an access code upon expiration of the usage timer. Thus, the content source 104 and/or presentation device 102 are not powered off, but rather are ready for the next user to come along and log into their account. In at least one embodiment, the content source 104A may output an indicator in association with the presented content that indicates a remaining time before the expiration of the usage timer.

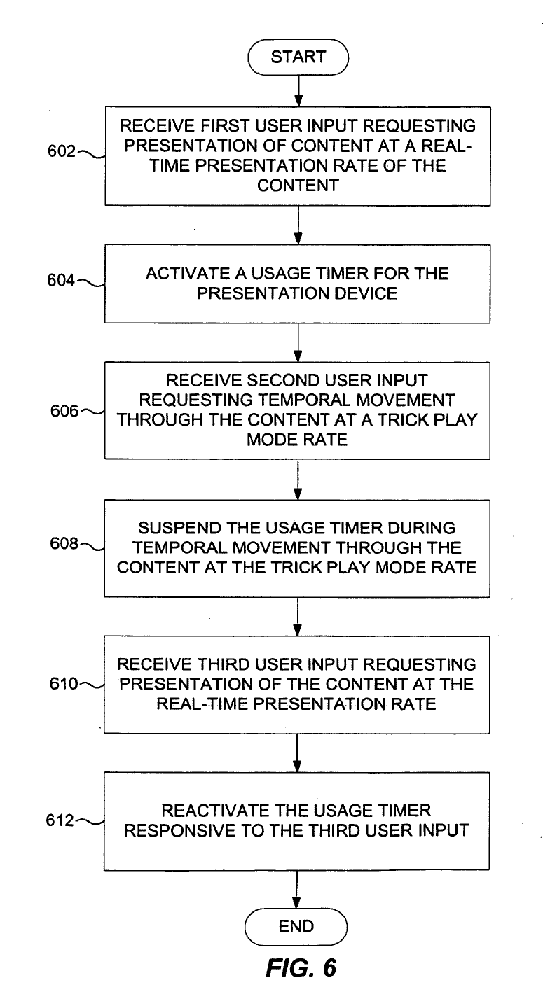

FIG. 5 illustrates a screenshot 500 of an embodiment of content outputted for presentation by the content source 104 of FIG. 1. As illustrated in FIG. 5, the screenshot 500 includes an indicator 502 displayed in the left-hand corner of the screen that indicates that the user 106 has 15 minutes left on their time budget. In at least one embodiment, the indicator 502 appears momentarily (e.g., for 30 seconds) when the time budget reaches a remaining time of 15 minutes. In some embodiments, the indicator 502 may remain for the remaining time left on the budget, with the content source 104 (see FIG. 1) periodically updating the information displayed in the indicator 502. In other words, the indicator 502 may remain as a countdown timer for the time budget of the user 106.

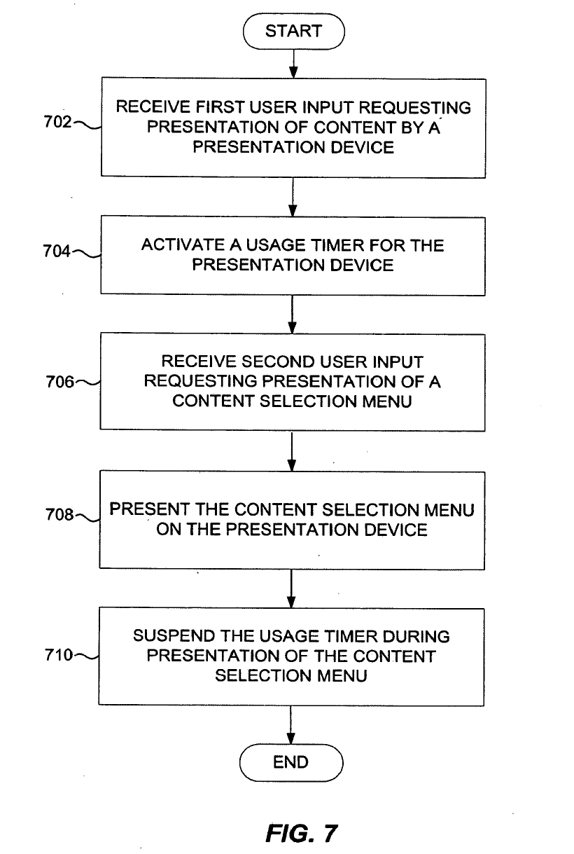

FIG. 6 illustrates an embodiment of a process for controlling usage timers for a presentation device and/or a content source. More particularly, FIG. 6 illustrates a process in which the usage timer for a presentation device is suspended during user activation of certain temporal movement functions of the presentation device and/or the content source. The operations of the process of FIG. 6 are not all-inclusive, and may comprise other operations not illustrated for the sake of brevity.

The method includes receiving first user input requesting presentation of content by a presentation device at a real-time presentation rate of the content (operation 602). For example, a user may initiate playback of a recorded video stored on a DVR or DVD disk, or may initiate playback of a recorded audio file (e.g., an MP3 file). In at least one embodiment, the user initiates the playback of the content using a play button on a remote control or on a front panel of the audio or video playback device.

The method further includes activating a usage timer for the presentation device (operation 604). The usage timer may be activated on a content source (e.g., a DVR) communicatively coupled to the presentation device that outputs content for presentation by the presentation device. Thus, the content source can cease outputting the content for presentation by the presentation device once the usage timer expires.

The method further includes receiving second user input requesting temporal movement through the content at a trick play mode rate. The trick play mode rate is different than the real-time presentation rate of the content. In at least one embodiment, the trick play mode rate is greater than the real-time presentation rate. For example, the trick play mode rate may be a 4× speed of playback of the content (e.g., fast forwarding through the content). In other embodiments, the trick play mode rate may be less than the real-time presentation rate of the content (e.g., stepping through the frames one by one).

The trick play mode rate may be in either playback direction of the content (e.g., fast forwarding or reversing through the content). Other trick play mode rates include pause (e.g., a presentation rate of zero) or stepping through indexed portions of the content. For example, the user may request to skip ahead one chapter in recorded video content. If the content comprises an audio track within a music play list, then the temporal movement may include skipping ahead or behind one or more audio tracks in the play list.

The method further includes suspending the usage timer during temporal movement through the content at the trick play mode rate (operation 608). For example, the user may activate the fast-forward button of a remote control to locate a point of interest in the video content. When the user activates the fast-forward function, then the content source suspends the usage timer and begins playback of the content at the trick play mode presentation rate. The usage timer remains suspended until the user re-activates presentation of the content at the real-time presentation rate.

The method further includes receiving third user input requesting presentation of the content by the presentation device at the real-time presentation rate (operation 610). For example, if the content source is presently fast-forwarding through the content, then the user may press a play button on a remote control to initiate playback of the content at the real-time presentation rate.

The method further includes re-activating the usage timer responsive to the third user input (operation 612). Thus, the content source 104A begins debiting the time budget of the user as the content is presented by the presentation device at the real-time presentation rate of the content.

FIG. 7 illustrates another embodiment of a process for controlling usage timers for a presentation device and/or a content source. More particularly, FIG. 7 illustrates a process in which the usage timer for a presentation device is suspended while a user views a content selection menu outputted by a content source and/or a presentation device. The operations of the process of FIG. 6 are not all-inclusive, and may comprise other operations not illustrated for the sake of brevity.

The method includes receiving first user input requesting presentation of content by a presentation device (operation 702). Operation 702 may be performed similarly as described in operation 602 of FIG. 6. The method further includes activating a usage timer for the presentation device (operation 704). Operation 704 may be performed similarly as described in operation 604 of FIG. 6.

The method further includes receiving second user input requesting presentation of a content selection menu (operation 706) and presenting the content selection menu on the presentation device (operation 708). The content selection menu may comprise any type of menu that displays one or more pieces of content that a user can select for presentation on a presentation device. For example, the content selection menu may be an electronic programming guide of broadcast content. In at least one embodiment, the content selection menu presents a selection of recorded videos available for viewing by a user. In other embodiments, the content selection menu presents a selection of other stored content, such as audio files or images available for presentation by a user. A content source (e.g., a DVR, set-top box or MP3 player) may output the content selection menu for presentation on the presentation device.

The method further includes suspending the usage timer during presentation of the content selection menu (operation 710). Thus, while the user is selecting content for presentation by the presentation device, their time budget is not debited for the time spent browsing the content selection menu. After the user leaves the content selection menu (e.g., returns to watching television or recorded content), then the usage timer is re-activated, and the time budget of the user is debited for the subsequent time spent watching television or experiencing other presentation content.

In at least one embodiment, a set-top box, when presenting an electronic programming guide, omits a preview of a channel last viewed on the presentation device. For example, if the user is watching a movie and opens the electronic programming guide on the set-top box, then the set-top box will display the electronic programming guide without the preview window of the movie normally present in the electronic programming guide. Thus, a user cannot defeat the usage timer by watching television while in the electronic programming guide.

Although specific embodiments were described herein, the scope of the invention is not limited to those specific embodiments. The scope of the invention is defined by the following claims and any equivalents therein.

What is claimed is:

1. A method for controlling usage times for a presentation device, the method comprising:
receiving first user input requesting presentation of content on a presentation device at a real-time presentation rate of the content;
activating a usage timer for the presentation device;
receiving second user input requesting temporal movement through the content by the presentation device at a trick play mode rate that is different than the real-time presentation rate of the content; and
suspending the usage timer during temporal movement through the content at the trick play mode rate.

2. The method of claim 1, wherein the content comprises a video stream.

3. The method of claim 2, further comprising:
outputting the video stream, from a digital video recorder, at the trick play mode rate, for presentation on the presentation device.

4. The method of claim 1, wherein the content comprises audio content.

5. The method of claim 1, wherein the trick play mode rate is greater than the real-time presentation rate.

6. The method of claim 1, wherein the first user input requests pausing of the content.

7. The method of claim 1, further comprising:
receiving third user input requesting presentation of the content by the presentation device at the real-time presentation rate;
presenting the content at the real-time presentation rate responsive to the third user input; and
reactivating the usage timer responsive to the third user input.

8. The method of claim 7, wherein presenting the content at the real-time presentation rate further comprises:
displaying an indicator in association with the content that indicates a remaining time on the usage timer.

9. A method for controlling usage times for a presentation device, the method comprising:
receiving first user input requesting presentation of content on a presentation device;
activating a usage timer for the presentation device;
receiving second user input requesting presentation of a content selection menu;
presenting the content selection menu on the presentation device; and
suspending the usage timer during presentation of the content selection menu.

10. The method of claim 9, wherein the content selection menu comprises an electronic programming guide of broadcast content.

11. The method of claim 10, wherein presenting the content selection menu on the presentation device further comprises:
presenting the electronic programming guide without a preview of a channel last viewed on the presentation device.

12. The method of claim 9, wherein the content selection menu comprises a listing of recorded video content available for playback by a digital video recorder.

13. The method of claim 9, further comprising:
suspending the usage timer during loading of content selected from the content selection menu.

14. A digital video recorder comprising:
a storage medium that stores recorded video content;
an interface module that receives first user input requesting presentation of the recorded video content at a real-time presentation rate of the recorded video content; and
a processor communicatively coupled to the storage medium and communicatively coupled to the interface module that outputs the recorded video content for presentation on a presentation device at the real-time presentation rate responsive to the first user input, and that activates a usage timer for the presentation device, the usage timer limiting a user's viewing of the recorded video content on the presentation device to a specified period of time;
wherein the interface module receives second user input requesting presentation of the recorded video content at a trick play mode presentation rate that is different than the real-time presentation rate of the content;
wherein the processor suspends the usage timer during presentation of the recorded video content at the trick play mode presentation rate.

15. The digital video recorder of claim 14, wherein the interface module receives third user input requesting presentation of the recorded video content on the presentation device at the real-time presentation rate, and wherein the processor outputs the recorded video content for presentation at the real-time presentation rate and re-activates the usage timer responsive to the third user input.

16. The digital video recorder of claim 14, wherein the processor outputs an indicator in association with the recorded video content that indicates a remaining time on the usage timer.

17. A content source comprising:
an input module that receives video content from at least one input source;
an interface module that receives first user input requesting presentation of the video content; and
a processor communicatively coupled to the input and communicatively coupled to the interface that outputs the video content for presentation on a presentation device, and that activates a usage timer for the presentation device, the usage timer limiting a user's viewing of the video content to a specified period of time;
wherein the interface receives second user input requesting presentation of a content selection menu;
wherein the processor outputs the content selection menu for presentation by the presentation device responsive to the user input;
wherein the processor suspends the usage timer during presentation of the content selection menu.

18. The content source of claim 17, wherein the content selection menu comprises an electronic programming guide of broadcast content.

19. The content source of claim 17, wherein the processor outputs the electronic programming guide for presentation by the presentation device without a preview of a channel last viewed on the presentation device.

20. The content source of claim 17, wherein the processor further suspends the usage timer during loading of content selected from the content selection menu.
